(19) United States
(12) Patent Application Publication
(10) Pub. No.: US 2009/0158431 A1
(43) Pub. Date: Jun. 18, 2009

(54) METHOD OF DETECTING POLYMORPHIC SHELL CODE

(75) Inventors: Dae Won KIM, Daejeon (KR); Ik Kyun KIM, Daejeon (KR); Yang Seo CHOI, Daejeon (KR); Seung Yong YOON, Daejeon (KR); Byoung Koo KIM, Daejeon (KR); Jin Tae OH, Daejeon (KR); Jong Soo JANG, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/333,490

(22) Filed: Dec. 12, 2008

(30) Foreign Application Priority Data
Dec. 18, 2007 (KR) 10-2007-0133772

(51) Int. Cl. G06F 11/00

(52) U.S. Cl. 726/23

(57) ABSTRACT

There is provided a method of detecting a polymorphic shell code. The decoding routine of the polymorphic shell code is detected from received data. In order for the decoding routine to access the address of an encoded code, the address of a currently executed code is stored in a stack, the value is moved in a register table, and it is determined whether the value is actually used for operating a memory. Emulation is finally performed and the degree of correctness of detection is improved. Therefore, time spent on detecting the polymorphic shell code and an overhead are reduced and the correctness of detection is increased.

### CROSS-REFERENCE TO RELATED APPLICATION

This application claims the benefit of Korean Application No. 10-2007-0133772, filed on Dec. 18, 2007 in the Korean Intellectual Property Office, the disclosure of which is incorporated herein by reference.

### BACKGROUND OF THE INVENTION

1. Field of the Invention

The present invention relates to a network security technology, and more particularly, to a method of detecting whether an encoded shell code exists in a network packet.

The present invention was supported by the IT R&D program of Ministry of Information and Communication (MIC) and Institute for Information Technology Advancement (IITA)[Project reference number: 2006-S-042-02, Title of the Project: Development of Signature Generation and Management Technology against Zero-day Attack].

2. Description of the Related Art

An emulation method of dynamically calculating register values with respect to an input packet using every byte data as a starting point is used for detecting whether an encoded shell code exists in a network packet in a conventional art. In this method, instructions must be performed one by one every byte as if a CPU actually performs operation so that an operation overhead is large.

In another method, an instruction that finds out the address of an encoded code is found out through a linear or recursive disassemble, an instruction regarded as the start of the shell code is found out in the inverse direction, and emulation is performed from the instruction to detect the presence of a loop. In this method, the instruction that finds out the address can be missed due to the error of the disassemble, an emulation overhead can exist in a shell code that is not a polymorphic shell code, and a polymorphic shell code without a loop cannot be detected.

### SUMMARY OF THE INVENTION

In order to solve the above-described problems, it is an object of the present invention to provide a method of performing only a disassemble every byte in order to detect an instruction that finds out the address of an encoded code to remarkably reduce an operation overhead and not to miss the corresponding instruction in comparison with a method of performing emulation every byte.

It is another object of the present invention to provide a method of finding out whether a register item in which the address of an encoded code is provided is actually used for a memory operation so that an unnecessary emulation overhead can be reduced when a shell code is not a polymorphic shell code.

It is still another object of the present invention to provide a method of detecting an operation for storing a decoded code in continuous address spaces through emulation so that a polymorphic shell code without a loop can be detected.

A method of detecting a polymorphic shell code includes determining whether the address of a currently executed code is stored in a register table in order to detect instruction that finds out the address of an encoded code in received network data, determining whether a register item in which the address of the currently executed code is stored is used as an input of instruction that operates a memory, detecting instructions that define remaining register items used as the input of the instruction that operates the memory when the address of the currently executed code is used as the input of the instruction that operates the memory, and performing emulation from instruction that stores the address of the currently executed code stored in the register table in a stack or instruction positioned first among instructions that define the remaining register items and a shell code is determined as a polymorphic shell code when data is stored in the memory as a result of performing the emulation.

According to the method of detecting the polymorphic shell code, an operation overhead is remarkable reduced and the corresponding instruction is not missed in comparison with a method of performing emulation every byte. In addition, it is determined whether the register item including the address of the encoded code is used for operating the memory so that it is possible to reduce unnecessary emulation overhead when a shell code is not the polymorphic shell code. An operation that stores the encoded code in continuous address spaces through emulation is detected so that the polymorphic shell code that is not formed of a repeated sentence can be detected.

### BRIEF DESCRIPTION OF THE DRAWINGS

FIG. 1 is a flowchart in which the flow of a method of detecting a polymorphic shell code according to the present invention is illustrated;

FIG. 2 is a flowchart of describing a method of detecting the flow of finding out the address of an encoded code in FIG. 1 in detail;

FIG. 3 is a flowchart of describing a method of detecting whether a register item in which the address of a currently executed code is stored is used for reading a memory in FIG. 1 in detail;

FIG. 4 is a flowchart of describing a method of detecting an instruction that defines the remaining register item used for reading the memory in FIG. 1 in detail; and

FIG. 5 is a flow chart of describing a method of detecting whether a value is stored in continuous memories while performing emulation in FIG. 1 in detail.

### DETAILED DESCRIPTION OF THE INVENTION

The advantages and characteristics of the present invention and a method of achieving the same will be clarified with reference to the following embodiments together with the accompanying drawings. However, the present invention is not limited to embodiments disclosed hereinafter but can be realized to have various forms. The present embodiments are provided to complete the disclosure of the present invention and to completely inform those skilled in the art of the scope of the present invention. The present invention is defined by the scope of the claims. The same elements are denoted by the same reference numerals.

In order to avoid signature based network security systems, a polymorphic shell code is actively used. According to the present invention, a new static analyzing method for detecting the decoding routine of the polymorphic shell code is provided. In this method, in order to access the address of a code in which the decoding routine is encoded, the address of a currently executed code is stored in a stack, the value is moved between the items of a register table, and it is determined whether the value is used for an actual memory access operation.

The main object of an attacker is to obtain a right to control a remote host. The right to control the remote host can be obtained since a vulnerable service by which the attacker changes the control flow of the remote host to arbitrarily execute a malicious code exists. In a common method of obtaining the right to control the remote host, a shell code is transferred by the vulnerable service. The newest attack detecting technologies based on a network have the use area thereof increased. However, most of the newest attack detecting technologies is signature based, which is basic limitation. Due to the limitation, a shell code for which a polymorphic method is used cannot be easily detected.

However, as described above, since the attackers cannot easily predict the address of the encoded code of the polymorphic shell code in the remote host, the address of a currently executed code is stored in a stack through a decoding routine and the value is used as an address for accessing the memory of the encoded code. Therefore, according to the present invention, a method of detecting the address of the currently executed code is used.

According to the present invention, the polymorphic shell code for which a disassemble preventing method and a self-code correcting method are used can be detected. As a result, according to the present invention, a method of detecting the polymorphic shell code having a similar performance to and a smaller overhead than a method of detecting the hybrid of the polymorphic shell code can be provided. In addition, since the disassemble is performed every byte in order to find out a GetPC code in which the address of the currently executed code is stored in the stack, the polymorphic shell code can be detected by analyzing the characteristics of the decoding code immediately before the self-correcting code operates without being affected by the disassemble preventing method.

Hereinafter, the present invention will be described with reference to the accompanying drawings.

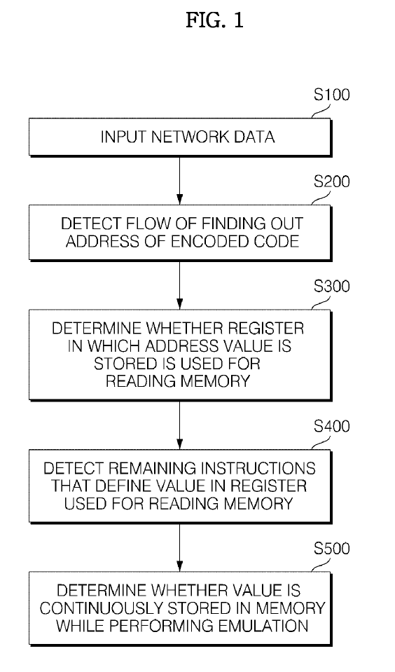

FIG. 1 is a flowchart illustrating the flow of a method of detecting a polymorphic shell code according to the present invention.

First, in the method of detecting the polymorphic shell code, it is determined whether the address of the currently executed code stored by a decoding routine is used for accessing a memory. Then, it is finally determined whether processes of storing data in a memory space having a fixed distance through emulation are repeated to improve correctness.

When data (collected network traffics or files) regarded as including the polymorphic shell code are input in S100, instructions of finding out the address of the encoded code from the input data are detected in S200. In S200, the GetPC instruction that performs the disassemble every byte to store the address of the currently executed code in the stack is found out and it is determined whether the address of the currently executed code stored in the stack is stored in a register table.

Then, in S300, it is determined whether the address of the currently executed code stored as the register value of one register item in the register table is used as the input of the instruction that operates the memory. At this time, the address of the currently executed code detects a connection relationship between the stored register item and the other register items so that it is determined whether the memory is operated although the register value moves to another register item. In S400, instructions that define the value of the remaining register item used as the input of the instruction that operates the memory are detected.

Finally, in S500, emulation is performed from the instruction positioned first among the detected instructions to determine whether the value is stored in the memory by the number of times no less than previously set number of times. When the value is stored in the memory by the number of times no less than the previously set number of times, it is finally determined that the decoding routine is the decoding routine of the polymorphic shell code.

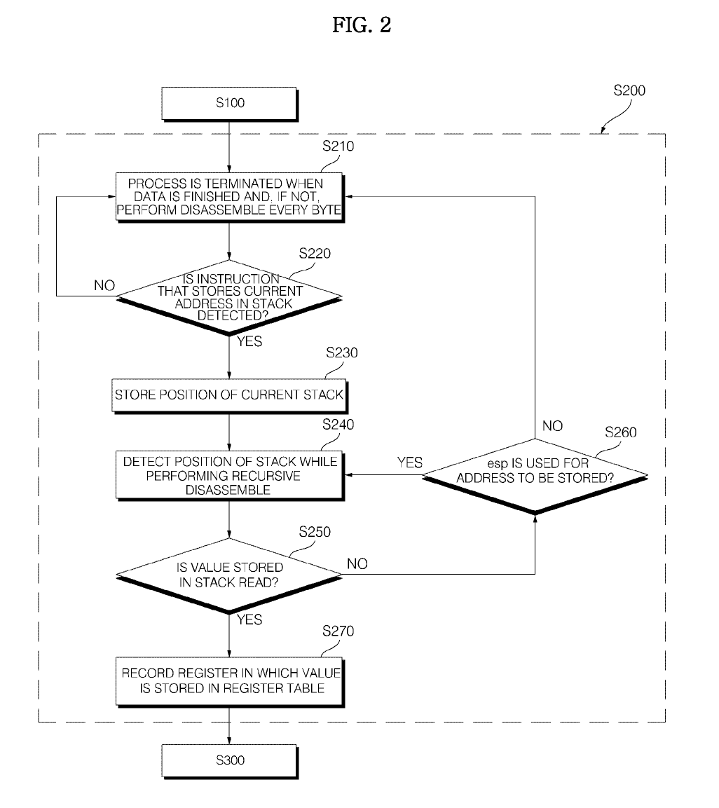

FIG. 2 is a flowchart of describing a method of detecting the flow of finding out the address of an encoded code in FIG. 1 in detail.

In S200, the polymorphic shell code stores the address of the currently executed code in the stack and determines whether the value is stored in a specific register item in the register table. The stored value is used for finding out the address of the encoded code. This process is formed of the process of detecting the GetPC as described above.

The GetPC that stores the address of the currently executed code in the stack is a code essential for finding out the access address of the original code or for using the self-correcting method. The GetPC is not required when information items on the specific register item are known at the point of time where the polymorphic shell code is provided on the memory of the host. However, it is not easy for the attacker to predict such an environment. Therefore, the attacker commonly creates the decoding routine using the GetPC code.

The instructions that can be used as the GetPC include call, fsave, fnsave, fstenv, and fnstenv. According to the present invention, the disassemble is performed every byte to detect the above GetPC. When the GetPC is detected, a virtual stack space is generated and it is assumed that the middle of the space is the position of the current stack, in which the address of the currently executed code is stored. In the case of call, the address of the currently executed code is stored in the position of the current stack and f series instructions are stored in the corresponding position of the stack calculated by static analysis. For example, in the case of fnstenv 14/28 byte [esp-0c], like in call, the address of the currently executed code is stored in the position of the current stack. When the f series are not related to a stack operation, it is determined that the routine is not the decoding routine. This is because the possibility of accessing an arbitrary memory excluding the stack is low since the attacker cannot know the memory of the host and the states of various registers.

In S210, when data created in S100 is input, the disassemble is performed using every byte as the starting point of time.

In S220, it is determined whether the disassembled instruction is one of fsave, fnsave, fstenv, fnstenv, and call. This is because the instructions that can be used as the GetPC store the address of the currently executed code in the stack as described above. At this time, in the case of fsave, fnsave, fstenv, and fnstenv, esp must be included in the operand of the instruction. fnstenv 14/28 byte [esp-0c] is an example.

In S230, the current address is stored in the virtual stack space and the current position of the stack is recorded.

In S240, a change in the position of the stack is detected while performing recursive disassemble from the instruction of S220. In the recursive disassemble, the address of the code to be disassembled is changed in accordance with divergence. For example, when the instruction of S220 is call 000a, the address to be disassembled next is 000a. In detecting the position of the stack, the position of the stack is increased in the case of push and the position of the stack is reduced in the case of pop.

In S250, it is determined whether the address of the currently executed code stored in the stack is stored in the specific register item in the register table, which can be performed by determining whether the instructions are pop, mov xxx, and [esp] instructions when the position of the stack is the position recorded in S230.

In S260, when the address of the currently executed code stored in the stack is not recorded in the register table, since a decoding code is not revealed although the memory access instruction is revealed, the process is returned to S210 to start performing analyzing from the next byte. Since errors can be generated in the current program when the value is stored not in the address space desired by a shell code developer but in an arbitrary memory address, in the polymorphic shell code, the instruction stored in the memory is not used first without reading the address of the currently executed code.

In S270, the register item in which the address of the currently executed code stored in the stack is stored is recorded in the register table. For example, when instructions in which fnstenv 14/26 byte [esp-0c], mov edi, f35e0f78, and pop ebx exist, the address of the currently executed code is recorded as the register item ‘ebx’ in the register table.

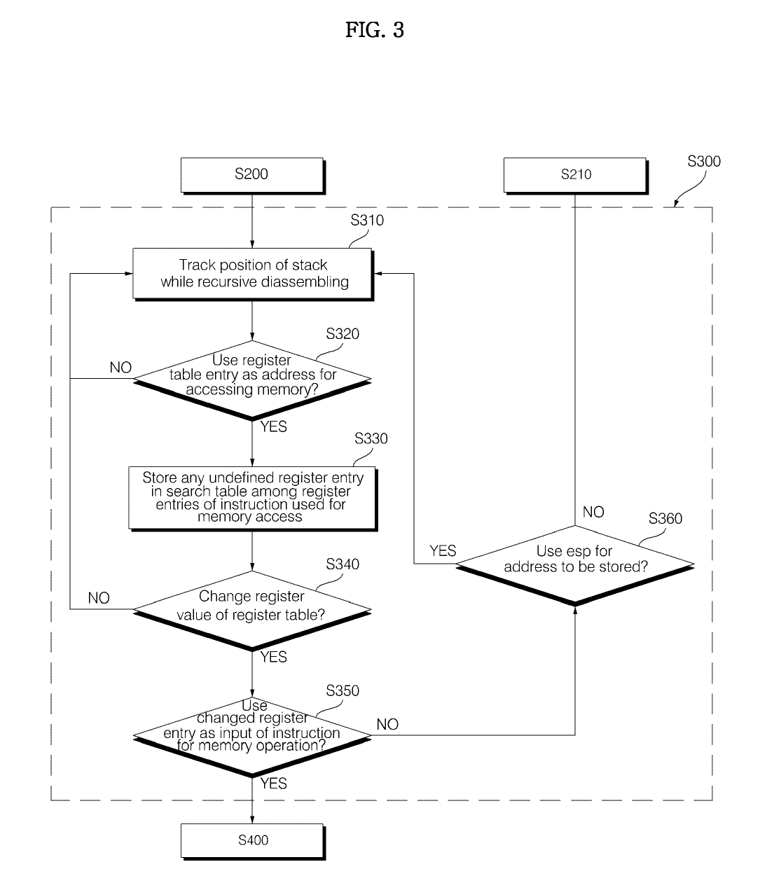

FIG. 3 is a flowchart of describing a method of detecting whether a register item in which the address of a currently executed code is stored is used for reading a memory in FIG. 1 in detail.

In S300, a relationship in which the register value recorded in the specific register item of the register table moves to another register item is detected so that it is finally determined whether the value is used for the instruction that reads the memory, which is performed by detecting the register items that load the address of the currently executed code.

As described above, the decoding routine stores the address of the currently executed code stored in the virtual stack space in the specific register item. When the instruction that accesses the memory without reading the value stored in the specific register item is revealed, the shell code is not the polymorphic shell code. This is because, since the attacker does not know the state of the memory of the host in detail, the possibility of accessing an arbitrary memory region excluding the address of the code stored in the stack is low.

However, if necessary, in order to make the detection of the decoding routine complicated, the register value stored in the specific register item is moved to another register item. Therefore, in S300, it is determined whether the value stored in the specific register item is used for the instruction that reads the memory and it is also determined whether the value stored in the register item is used for the instruction that reads the memory after being moved to another register item.

In S310, the recursive disassemble is performed from the next instruction of S270 to detect the position of the stack.

In S320, it is determined whether the address read from the specific register item in the register table in order to find out the position of the encoded code is used for reading the memory. That is, the instruction that reads the data of the encoded code, that decodes the data, and that stores the decoded data is found out. For example, in reading the memory like xor [ebx+15], edi, it is determined whether the register item ebx registered in the register table is used in S200.

In S330, in xor [ebx+15], edi, edi is recorded in a search table. This is because the instruction that defines edi must be detected when emulation is performed later in order to finally determine in which position of the data input in S100 edi exists and whether the shell code is the polymorphic shell code. That is, in S330, the register items that are not defined yet among the register items of the instruction used for reading the memory are stored in a search table.

On the other hand, a method of determining whether, after the value stored in the register item is moved to another register item, the value is used for the instruction that reads the memory is as follows. As described above, in order to make polymorphic shell code detecting programs confused in detecting the pattern that loads the address of the currently executed code in the position of the stack in which the currently executed code is stored in the decoding routine, various instructions can be inserted as dummy. Therefore, it is necessary to detect the register value stored in the specific register item.

According to the present invention, the position of the virtual stack is detected by push/pop and inc/dec/sub/add that is basic operation instruction. For example, in the case of inc esp, 4, the value of a virtual stack pointer is changed. Then, it is determined whether the value is loaded in another register item in the position of the stack in which the address of the currently executed code is stored by pop and mov.

In S340 and S350, it is determined whether the register value recorded in the specific register item of the register table is moved to another register item. For example, in the case of move eax, ebx or mov ecx, ebx+0x0c, eax or ecx is recorded as another register item in the register table. As described above, the register item to which the register value is moved is used for memory access instruction, it has the same effect as the register value stored first in the register item is used.

Other than mov, after the address of the currently executed code stored in the specific register item is pushed, the address can be popped to another register item and the value can be moved to another register item through arithmetic or logical operation instruction. In the former, a connection relationship can be found out by detecting the stack. In the latter, the operand part of the instruction is divided into an input and output and, when a register item in a connection relationship exists on the side of the input and a new register item exists on the side of the output, the new register item is included in the connection relationship.

On the other hand, due to the reasons described in S360 and S260, when the instruction that reads the memory using the register item that is not recorded in the register table exists, the process is returned to S210 to start performing analysis in the next byte.

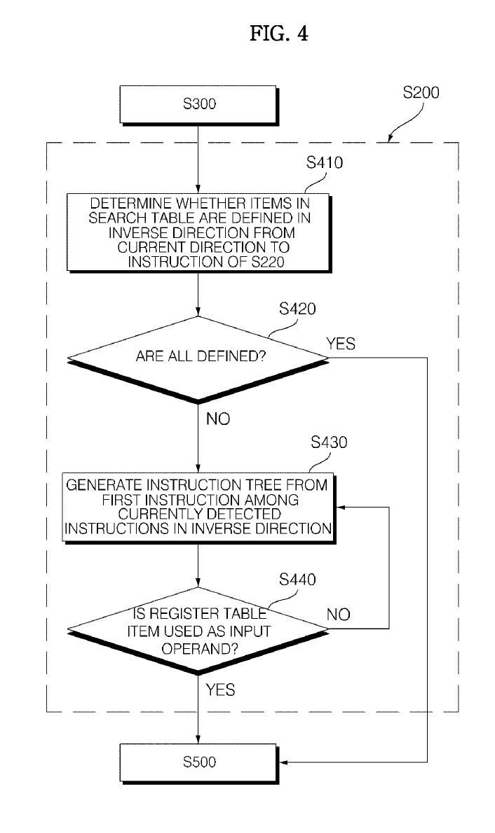

FIG. 4 is a flowchart of describing a method of detecting an instruction that defines the remaining register item used for reading the memory in FIG. 1 in detail.

In S400, the first instruction is found out among the instructions that define the value of the register item recorded in a search table before performing emulation. This is because a repetition executing pattern that reads, decodes, and records the encoded part can be detected only when emulation is started from the first instruction.

In S410, it is determined whether the instruction that defines the register items stored in the search table exists in the reverse direction from the instruction detected in S320. For example, when mov edi, f35e0f78 is revealed, it is recorded that the value is defined in edi in the search table.

In S420, it is determined whether all of the register items in the search table are defined when the processes till S220 are detected in the reverse direction. In the case where the processes till S220 are performed, when it is determined that all of the register items in the search table are defined, the process proceeds to the emulation of S500.

However, when it is determined that all of the register items in the search table are not defined, the instruction is detected in the reverse direction from the first instruction among currently detected instructions. That is, in S430 and S440, in order to find out the instruction that defines the register items whose values are not defined in the search table, the instructions are detected in the reverse direction of the first instruction among the currently detected instructions. In the address of S220, instructions that do not overlap byte data that constitutes the instruction of S220 are found out when disassemble is performed by moving the address of S220 backward by 1, 2, 3 . . . bytes. Among the instructions, it is determined whether the instructions that define all of the values of the register items whose values are not defined in the search table exist. When it is determined that the instructions do not exist, the above analysis is repeated based on each of the instructions.

As a result, one tree of the instructions that can define all of the registers in the search table is found out. The first instruction of the tree becomes the starting address of emulation.

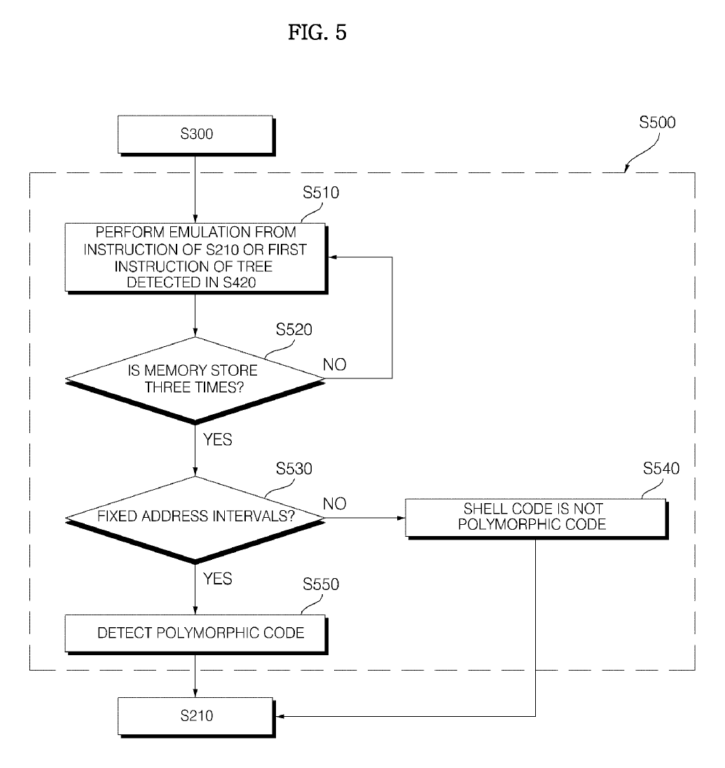

FIG. 5 is a flow chart of describing a method of detecting whether a value is stored in continuous memories while performing emulation in FIG. 1 in detail.

In S500, a pattern that records the value in the memory at fixed address intervals is detected. The pattern reads the data of the encoded code, decodes the read data, and records the decoded data. When the characteristics of the emulation of FIG. 5 are detected while including all of the characteristics described in FIGS. 2 to 4, the possibility in which the pattern is the decoding part of the polymorphic shell code is very high. Only arithmetic, logic, divergence, and operation are required for emulation. For example, add, xor, and jmp are provided.

In S510, S520, S530, S540, and S550, it is determined three times whether the value is recorded in the memory when instructions are performed through emulation and, when the address of the memory in which the value is recorded has fixed address intervals, it is determined that the shell code is the polymorphic shell code.

At this time, the three times are previously set and can be increased and reduced if necessary.

Hereinafter, processes of actually performing detection through the method according to the present invention will be described with reference to codes.

| 0000 | 31 c9 | xor ecx, ecx |
|---|---|---|
| 0002 | da c7 | fcmovb st(0), st(7) |
| 0004 | b1 23 | mov c1, 23 |
| 0006 | d9 74 24 f4 | fnstenv 14/28byte[esp−0c] |
| 000A | bf 78 0f 5e f3 mov edi, f35e0f78 | |
| 000F | 5b | pop ebx |
| 0010 | 31 7b 15 | xor[ebx+15], edi |
| 0013 | 03 7b 15 | add edi, [ebx+15] |
| 0016 | 83 c3 04 | add ebx, 4 |
| 0019 | e2 f5 | loop 0010 |

When disassemble is performed every byte with respect to the codes, the instruction of fnstenv 14/28 byte[esp-0xc] is detected in the value of d9 of the address of 0006.

Therefore, the value of the 0x00000006 that is the address of the currently executed code is stored in the virtual stack.

When recursive disassemble is performed from the instruction, the value stored in the stack by pop ebx is stored in ebx. Therefore, ebx is recorded in the register table as a register item.

When recursive disassemble is performed from the address of 0010, xor [ebx+15], edi that is the instruction that reads the value of the memory using ebx is detected.

ebx is the register item previously recorded in the register table. However, edi is not the register item previously recorded in the register table. Therefore, edi is recorded in the search table.

Then, when analysis is continuously performed in the inverse direction of the instruction before emulation, mov edi, f35e0f78 that defines the value of edi is detected. That is, the instruction that defines edi is found out. Therefore, it is recorded that the value of edi of the search table is defined.

Since all of the register items of the search table are defined, emulation is performed from the address of 0006.

When xor [ebx+15], edi that records data in the memory by loop 0010 of the address of 0019 is executed three times, the pattern of the polymorphic shell code that has fixed address intervals and whose value is recorded in the memory is detected.

Hereinafter, codes by which the address of the currently executed code is stored in a register item and is moved to another register item will be described as follows.

| | |
|---|---|
| 0002 59 | pop ecx |
| 0003 eb 05 | jump 000a |
| 0005 e8 f8 ff ff ff | call 0002 |
| 000A 49 | dec ecx |
| 000B 49 | dec ecx |
| ... | |
| 001B 49 | dec ecx |
| 001C 51 | push ecx |
| 001D 5a | pop edx |
| 001E 6a 46 | push 46 |
| *870020 58 | pop eax |
| 0021 30 42 31 | xor [edx+31], al |

The address of 0002 is called from the instruction having the address of 0005 and the address of the currently executed code is recorded in the register table as the register item of ecx. Then, ecx is recorded in the register table as another register item of edx through the instruction of push ecx of the address of 001C and the instruction of 001D 5a pop edx. Then, the register item of edx having the same register value is used for reading the memory by the instruction of xor [edx+31], a1. Therefore, it is determined whether the register value moves between the register items and emulation is performed after a connection relationship between the register items is completely grasped so that it is determined whether data has the decoding routine of the polymorphic shell code.

According to the present invention, computer readable codes are realized in computer readable recording media. The computer readable recording media include all kinds of recording apparatuses in which data that can be read by a computer system is stored. The computer readable recording media include a read only memory (ROM), a random access memory (RAM), a CD_ROM, a magnetic tape floppy disk, and an optical data storage apparatus. In addition, the recording medium realized in the form of a carrier wave (for example, transmission through the Internet) is included. In addition, the computer readable recording media are dispersed into the computer system connected by a network so that the computer readable codes can be stored and executed.

Although embodiments of the present invention have been described with reference to drawings, these are merely illustrative, and those skilled in the art will understand that various modifications and equivalent other embodiments of the present invention are possible. Consequently, the true technical protective scope of the present invention must be determined based on the technical spirit of the appended claims.

What is claimed is:

1. A method of detecting a polymorphic shell code, comprising:
determining whether an address of a currently executed code is stored in a register table in order to detect instruction that finds out an address of an encoded code in received network data;
determining whether a register item in which the address of the currently executed code is stored is used as an input of instruction that operates a memory;
detecting instructions that define remaining register items used as the input of the instruction that operates the memory when the address of the currently executed code is used as the input of the instruction that operates the memory; and
performing emulation from instruction that stores the address of the currently executed code stored in the register table in a stack or instruction positioned first among instructions that define the remaining register items and a shell code is determined as a polymorphic shell code when data is stored in the memory as a result of performing the emulation.

2. The method of claim 1, wherein detecting the instruction that finds out the address of the encoded code comprises:
performing disassemble of the received data;
determining whether instruction that stores the address of the currently executed code among disassembled codes in a stack exists; and
determining whether the value stored in the stack by the detected instruction is stored in a register table.

3. The method of claim 2, wherein detecting the instruction that finds out the address of the encoded code further comprises detecting a change in a position of the stack while performing disassemble from the detected instruction when it is determined that the instruction that stores the address of the currently executed code in the stack exists,
wherein detecting the change in the position of the stack is terminated when the value stored in the stack by the detected instruction is stored in a register table.

4. The method of claim 1, wherein determining whether the register item in which the address of the currently executed code is stored is used as the input of the instruction that operates the memory further comprises:
determining whether instruction that moves a register value stored in the register item to another register item exists; and
detecting the register value in accordance with the instruction when it is determined that the instruction that moves the register value stored in the register item to another register item exists,
wherein detecting the register value is terminated when another register item to which the register value is moved is used as the input of the instruction that operates the memory.

5. The method of claim 1, wherein detecting the instruction that define remaining register items used as the input of the instruction that operates the memory further comprises determining whether instruction that defines the remaining register items exists from current instruction to instruction that stores the address of the currently executed code stored in the register table in the stack,
wherein the emulation is performed when it is determined that the instruction that defines the remaining register items exists.

6. The method of claim 5, further comprising determining whether the instruction that defines the remaining register items exists in an inverse direction of the instruction that stores the address of the currently executed code stored in the register table in the stack when it is determined that the instruction that defines the remaining register items does not exist from the current instruction to the instruction that stores the address of the currently executed code stored in the register table in the stack,
wherein the emulation is performed when it is determined that the instruction that defies the remaining register items exists in determining whether the instruction that defines the remaining register items exists in the inverse direction.

7. The method of claim 1, wherein, in performing the emulation and determining the polymorphic shell code, a shell code is determined as the polymorphic shell code when storing the memory is performed for number of times no less than previously set number of times while performing the emulation from the first instruction.

8. The method of claim 7, wherein performing the emulation and determining the polymorphic shell code further comprises:
determining whether the address of the stored memory has fixed intervals when storing the memory is performed for number of times no less than the previously set number of times,
wherein, when it is determined that the address of the stored memory has the fixed intervals, a shell code is determined as the polymorphic shell code.
